(19) United States
(12) Patent Application Publication
(10) Pub. No.: US 2026/0238273 A1
(43) Pub. Date: Aug. 13, 2026

(54) METHOD AND APPARATUS FOR SUPPORTING MULTIPLE CSIS IN A CSI REPORT

(71) Applicant: LENOVO (BEIJING) LIMITED, Beijing (CN)

(72) Inventors: Yingying LI, Beijing (CN); Hongmei LIU, Beijing (CN); Zhi YAN, Beijing (CN); Yuantao ZHANG, Beijing (CN); Haiming WANG, Beijing (CN)

(21) Appl. No.: 19/148,154

(22) PCT Filed: Jan. 18, 2023
(86) PCT No.: PCT/CN2023/072882

§ 371 Date: Jul. 15, 2025

(51) Int. Cl. H04B 7/06; H04W 72/232

(52) U.S. Cl. CPC H04B 7/0626; H04W 72/232

(57) ABSTRACT

Embodiments of the present disclosure relate to methods and apparatuses for supporting multiple channel state information (CSI) in a CSI report. According to some embodiments of the disclosure, a UE may: receive one or more CSI reporting configurations, wherein each of the one or more CSI reporting configurations is associated with one or more CSI reference signal (CSI-RS) resources, each of which is configured with a respective port number; receive a first indication indicating at least one of the following parameters for CSI reporting: one or more port numbers, one or more port subset patterns, one or more port number scaling factors, whether a single CSI or multiple CSIs are included in a CSI report, or one or more codebook configurations; and generate a first CSI report based on a first CSI reporting configuration of the one or more CSI reporting configurations and the first indication.

### TECHNICAL FIELD

Embodiments of the present disclosure generally relate to wireless communication technology, and more particularly to supporting multiple channel state information (CSI) in a CSI report.

### BACKGROUND

Wireless communication systems are widely deployed to provide various telecommunication services, such as telephony, video, data, messaging, broadcasts and so on. Wireless communication systems may employ multiple access technologies capable of supporting communication with multiple users by sharing available system resources (e.g., time, frequency and power). Examples of wireless communication systems may include fourth generation (4G) systems, such as long-term evolution (LTE) systems, LTE-advanced (LTE-A) systems, or LTE-A Pro systems and fifth generation (5G) systems, which may also be referred to as new radio (NR) systems.

A user equipment (UE) may be configured to report channel state information (CSI). For example, the UE may receive, from a base station (BS), a CSI reference signal (CSI-RS), where the UE may be configured to receive the CSI-RS associated with a CSI-RS port (e.g., an antenna port) number. The UE may measure the received CSI-RS and transmit a CSI report to the BS.

The industry desires technologies for improving CSI reporting in a wireless communication system.

### SUMMARY

Some embodiments of the present disclosure provide a user equipment (UE). The UE may include a transceiver, and a processor coupled to the transceiver. The processor may be configured to: receive one or more channel state information (CSI) reporting configurations, wherein each of the one or more CSI reporting configurations is associated with one or more CSI reference signal (CSI-RS) resources, each of which is configured with a respective port number; receive a first indication indicating at least one of the following parameters for CSI reporting: one or more port numbers, one or more port subset patterns, one or more port number scaling factors, whether a single CSI or multiple CSIs are included in a CSI report, or one or more codebook configurations; and generate a first CSI report based on a first CSI reporting configuration of the one or more CSI reporting configurations and the first indication.

In some embodiments of the present disclosure, the first CSI reporting configuration indicates a codebook configuration corresponding to each of the one or more port numbers, each of the one or more port subset patterns, each of the one or more port number scaling factors, each of a predefined set of port numbers, each of a predefined set of port subset patterns, or each of a predefined set of port number scaling factors.

Some embodiments of the present disclosure provide a BS. The BS may include a transceiver, and a processor coupled to the transceiver. The processor may be configured to: transmit, to a user equipment (UE), one or more channel state information (CSI) reporting configurations, wherein each of the one or more CSI reporting configurations is associated with one or more CSI reference signal (CSI-RS) resources, each of which is configured with a respective port number; transmit, to the UE, a first indication indicating at least one of the following parameters for CSI reporting: one or more port numbers, one or more port subset patterns, one or more port number scaling factors, whether a single CSI or multiple CSIs are included in a CSI report, or one or more codebook configurations; and receive, from the UE, a first CSI report based on a first CSI reporting configuration of the one or more CSI reporting configurations and the first indication.

In some embodiments of the present disclosure, the first indication is transmitted via radio resource control (RRC) signaling. In some embodiments of the present disclosure, the first indication is included in downlink control information (DCI) or a medium access control (MAC) control element (CE).

In some embodiments of the present disclosure, the first CSI reporting configuration indicates at least one of the following: a set of port numbers, a set of port subset patterns, a set of port number scaling factors, whether a single CSI or multiple CSIs are included in a CSI report, or a set of codebook configurations.

In some embodiments of the present disclosure, the one or more port numbers are selected from the set of port numbers. In some embodiments of the present disclosure, the one or more port subset patterns are selected from the set of port subset patterns. In some embodiments of the present disclosure, the one or more port number scaling factors are selected from the set of port number scaling factors. In some embodiments of the present disclosure, the one or more codebook configurations are selected from the set of codebook configurations.

In some embodiments of the present disclosure, the first CSI report includes a CSI for each of the one or more port numbers. In some embodiments of the present disclosure, the first CSI report includes a CSI for each of the one or more port subset patterns. In some embodiments of the present disclosure, the first CSI report includes a CSI corresponding to each of the one or more port number scaling factors. In some embodiments of the present disclosure, the first CSI report includes a CSI for each of a predefined set of port numbers. In some embodiments of the present disclosure, the first CSI report includes a CSI for each of a predefined set of port subset patterns. In some embodiments of the present disclosure, the first CSI report includes a CSI corresponding to each of a predefined set of port number scaling factors. In some embodiments of the present disclosure, the first CSI report includes a CSI corresponding to each of the one or more codebook configurations.

In some embodiments of the present disclosure, the first CSI reporting configuration indicates a codebook configuration corresponding to each of the one or more port numbers, each of the one or more port subset patterns, each of the one or more port number scaling factors, each of a predefined set of port numbers, each of a predefined set of port subset patterns, or each of a predefined set of port number scaling factors.

In some embodiments of the present disclosure, the first CSI reporting configuration indicates a first codebook configuration for the respective port number, and wherein a codebook configuration corresponding to each of the one or more port numbers, each of the one or more port subset patterns, each of the one or more port number scaling factors, each of a predefined set of port numbers, each of a predefined set of port subset patterns, or each of a predefined set of port number scaling factors is based on the first codebook configuration.

In some embodiments of the present disclosure, the first CSI reporting configuration indicates a first physical uplink control channel (PUCCH) resource for a single CSI and a second PUCCH resource for multiple CSIs.

In some embodiments of the present disclosure, the first CSI reporting configuration indicates a first physical uplink control channel (PUCCH) resource, and the first CSI report includes multiple CSIs, and wherein receiving the first CSI report includes receiving each of the multiple CSIs on a corresponding time instance of the first PUCCH resource.

In some embodiments of the present disclosure, the processor is further configured to transmit, to the UE, a second indication activating multiple CSI reporting in a CSI report.

In some embodiments of the present disclosure, the second indication activates at least one CSI reporting configuration which configures multiple CSI reporting among the one or more CSI reporting configurations. The first indication configures the first CSI reporting configuration with multiple CSI reporting and receiving the first CSI report includes receiving the first CSI report including multiple CSIs in response to the transmission of the second indication.

In some embodiments of the present disclosure, the first CSI report includes a single CSI in response to the BS transmitting a port adaptation indication to the UE, or in response to the BS transmitting a third indication deactivating multiple CSI reporting in a CSI report to the UE, or after a time offset from the transmission of the second indication.

In some embodiments of the present disclosure, the second or third indication is downlink control information (DCI) including a CSI request field or a semi-persistent (SP) CSI reporting on physical uplink control channel (PUCCH) activation/deactivation medium access control (MAC) control element (CE).

In some embodiments of the present disclosure, the first indication reuses a reserved bit(s) in a semi-persistent (SP) CSI reporting on physical uplink control channel (PUCCH) activation/deactivation medium access control (MAC) control element (CE).

Some embodiments of the present disclosure provide a method performed by a UE. The method may include: receiving one or more channel state information (CSI) reporting configurations, wherein each of the one or more CSI reporting configurations is associated with one or more CSI reference signal (CSI-RS) resources, each of which is configured with a respective port number; receiving a first indication indicating at least one of the following parameters for CSI reporting: one or more port numbers, one or more port subset patterns, one or more port number scaling factors, whether a single CSI or multiple CSIs are included in a CSI report, or one or more codebook configurations; and generating a first CSI report based on a first CSI reporting configuration of the one or more CSI reporting configurations and the first indication.

Some embodiments of the present disclosure provide a method performed by a BS. The method may include: transmitting, to a UE, one or more channel state information (CSI) reporting configurations, wherein each of the one or more CSI reporting configurations is associated with one or more CSI reference signal (CSI-RS) resources, each of which is configured with a respective port number; transmitting, to the UE, a first indication indicating at least one of the following parameters for CSI reporting: one or more port numbers, one or more port subset patterns, one or more port number scaling factors, whether a single CSI or multiple CSIs are included in a CSI report, or one or more codebook configurations; and receiving, from the UE, a first CSI report based on a first CSI reporting configuration of the one or more CSI reporting configurations and the first indication.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of CSI reporting in accordance with some embodiments of the present disclosure;

FIGS. 3a-3d illustrate exemplary port subset patterns in accordance with some embodiments of the present disclosure;

FIGS. 4a-7 illustrate schematic diagrams of CSI reporting in accordance with some embodiments of the present disclosure;

FIG. 8 illustrates an exemplary semi-persistent (SP) CSI reporting on physical uplink control channel (PUCCH) activation/deactivation medium access control (MAC) control element (CE) in accordance with some embodiments of the present disclosure;

FIGS. 9 and 10 illustrate flow charts of exemplary procedures of wireless communications in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8 and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

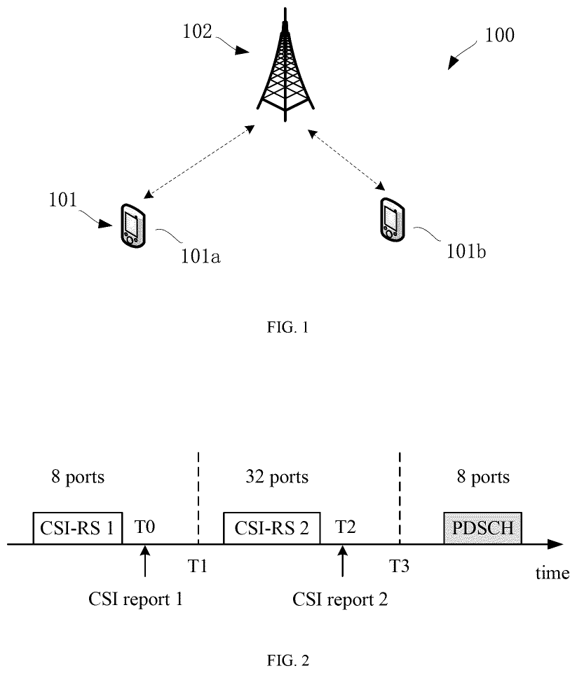

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, a BS may configure a configuration associated with a CSI report (e.g., via CSI-ReportConfig as specified in 3GPP specifications) for a UE. The configuration associated with the CSI report (also referred to as “CSI reporting configuration”) may indicate a resource for channel measurement (e.g., a CSI resource, which may be indicated by CSI-ResourceConfig as specified in 3GPP specifications). For example, CSI-ResourceConfig may define a group of one or more NZP-CSI-RS-ResourceSet, CSI-IM-ResourceSet and/or CSI-SSB-ResourceSet, as specified in 3GPP specifications. The CSI resource configuration may indicate the port(s) of a CSI-RS resource (e.g., a port number). In some examples, the number of ports of a CSI-RS resource (e.g., denoted as “P_{CSIRS}”) can be configured as 1, 2, 4, 8, 12, 16, 24, or 32.

Since a UE performs CSI measurements on the CSI-RS resource configured for the UE (which is associated with a configured port number as described above), the CSI report generated based on the measurements or the CSI included in the CSI report is associated with the configured port number.

In some embodiments of the present disclosure, the CSI reporting configuration may include a codebook configuration (e.g., via CodebookConfig as specified in 3GPP specifications), which is used to configure Type-I and Type-II codebooks for CSI reporting. The specific definitions of Type-I and Type-II codebooks can be found in 3GPP specifications and are incorporated herein. A codebook configuration may be related to the number of ports of the associated CSI-RS resource configured, for example, in a CSI reporting configuration.

For example, a codebook configuration may indicate the number of antenna ports in a first (e.g., horizontal) dimension (denoted as N₁) and the number of antenna ports in a second (e.g., vertical) dimension (denoted as N₂) and codebook subset restriction. The number of CSI-RS ports (i.e., P_{CSI-RS}), N₁ and N₂ may satisfy P_{CSI-RS}=2N₁N₂. For example, a codebook configuration may indicate the number of panels (denoted as N_{g}), the number of antenna ports in a first (e.g., horizontal) dimension (e.g., N₁) in a panel and the number of antenna ports in a second (e.g., vertical) dimension (e.g., N₂) in the pane, and a codebook subset restriction. The number of CSI-RS ports (i.e., P_{CSI-RS}), Ng, N₁ and N₂ may satisfy P_{CSI-RS} 2N_{g}N₁N₂.

In some embodiments of the present disclosure, the CSI reporting configuration may be used to configure a periodic or semi-persistent report transmitted on a physical uplink control channel (PUCCH), for example, on the cell in which the CSI reporting configuration is included), or to configure a semi-persistent or aperiodic report transmitted on a physical uplink shared channel (PUSCH) triggered by a DCI received on, for example, the cell in which the CSI reporting configuration is included (for example, the cell on which the CSI report is transmitted is determined by the received DCI). Accordingly, the types of CSI reporting configurations may include, for example, “periodic”, “semiPersistentOnPUCCH”, “semiPersistentOnPUSCH” and “aperiodic.” The “periodic” and “semiPersistentOnPUCCH” CSI reporting configurations may indicate the PUCCH resource to use for reporting the associated CSI(s) on a PUCCH (e.g., pucch-CSI-ResourceList as specified in 3GPP specifications). In some examples, one PUCCH resource may be related to one corresponding bandwidth part (BWP).

In some embodiments of the present disclosure, the DCI triggering the semi-persistent or aperiodic report on a PUSCH may include a CSI request field. The size (e.g., number of bits) of the CSI request field in the DCI is determined by a higher layer (e.g., radio resource control (RRC)) parameter (e.g., reportTriggerSize or reportTriggerSizeDCI-0-2 as specified in 3GPP specifications). For example, the field reportTriggerSize applies to DCI format 0_1 and the field reportTriggerSizeDCI-0-2 applies to DCI format 0_2.

A UE may be configured by higher layers with one or more lists of trigger states. For example, a UE may be configured with a list of aperiodic trigger states (for example, by the higher layer parameter CSI-AperiodicTriggerStateList as specified in 3GPP specifications). For example, a UE may be configured with a list of trigger states for semi-persistent reporting of a CSI (e.g., by the higher layer parameter CSI-SemiPersistentOnPUSCH-TriggerStateList as specified in 3GPP specifications). Each trigger state in the list of aperiodic trigger states may include a list of associated CSI reporting configurations. Each trigger state in the list of trigger states for semi-persistent reporting of a CSI may include an (e.g., one) associated CSI reporting configuration.

For semi-persistent reporting on a PUSCH, the CSI request field in a DCI (e.g., the cyclic redundancy check (CRC) bits of a DCI are scrambled with a semi-persistent (SP) CSI radio network temporary identifier (RNTI) (SP-CSI-RNTI)) may activate one trigger state of the list of trigger states for semi-persistent reporting of the CSI. In some examples, a codepoint of the CSI request field in the DCI is mapped to a corresponding SP-CSI triggering state according to, for example, the order of the positions of the configured trigger states in the list. For example, codepoint ‘0’ may be mapped to the triggering state in the first position and so on. Whether the trigger state indicated by the CSI request is activated or deactivated depends on other field(s) of the DCI and will be described later.

For aperiodic reporting, a trigger state is initiated using the CSI request field in a DCI. In some examples, when the CSI request field in the DCI is set to a predefined value (e.g., all the bits of the CSI request field are set to zero), no CSI (e.g., no new aperiodic CSI reporting) is requested. In some examples, when the number of configured CSI triggering states in the list of aperiodic trigger states is greater than 2^{N}^{_{TS}}-1, where NTs denotes the number of bits in the CSI request field, the UE receives a subselection indication (e.g., an aperiodic CSI trigger state subselection MAC CE as specified in 3GPP specifications). The subselection indication is used to map up to 2^{N}^{_{TS}}-1 trigger states to the codepoints of the CSI request field in the DCI. In some examples, NTs is configured by a higher layer parameter (e.g., reportTriggerSize as specified in 3GPP specifications), and N_{TS}∈{0,1,2,3,4,5,6}. In some examples, when the number of CSI triggering states in the list of aperiodic trigger states is less than or equal to 2^{N}^{_{TS}}-1, the CSI request field in the DCI directly indicates the triggering state. A non-zero codepoint of the CSI request field in the DCI is mapped to a CSI triggering state according to the order of the associated positions of the up to 2^{N}^{_{TS}}-1 trigger states in the list of aperiodic trigger states. For example, codepoint ‘1’ may be mapped to the triggering state in the first position and so on.

For example, for aperiodic reporting, the CSI request field may include 6 bits and thus include 63 codepoints to map to 63 triggering states. However, a UE may be configured with a list of aperiodic trigger states including, for example, 128 triggering states. The UE may receive a subselection indication selecting 63 or less triggering states from the 128 triggering states. The CSI request field in the DCI may then select a triggering state from the selected 63 or less triggering states.

As described above, the CSI request field in a DCI can select a (e.g., one) triggering state from the configured list of trigger states. The selected triggering state may be associated with a (e.g., one) CSI reporting configuration in the case of semi-persistent reporting. Another field(s) of the DCI may be used to further indicate whether the CSI reporting of the associated CSI reporting configuration is activated or deactivated.

In some embodiments, for semi-persistent CSI activation, a UE may first validate an SP-CSI DCI in a physical downlink control channel (PDCCH) by verifying that the CRC bits of the DCI are scrambled by an SP-CSI-RNTI. As an example, the UE may further verify that all of the following conditions are met:
“HARQ process number” bits in the DCI are set to all “0”s.
“Redundancy version” bits in the DCI are set to all “0”s.

In some embodiments, for semi-persistent CSI deactivation validation, a UE may first validate an SP-CSI DCI in a PDCCH by verifying that the CRC bits of the DCI are scrambled by an SP-CSI-RNTI. As an example, the UE may further verify that all of the following conditions are met:
“HARQ process number” bits in the DCI are set to all “0”s.
“Modulation and coding scheme” bits in the DCI are set to all “1”s.
“Resource block assignment” bits in the DCI are:
   if higher layer configures random access (RA) type 0 only, set to all “0”s;
   if higher layer configures RA type 1 only, set to all “1”s;
   If higher layer configures dynamic switch between RA type 0 and 1, then if the most significant bit (MSB) is “0”, set to all “0”s; else, set to all “1”s;
   For DCI 0_1, if higher layer configures RA type 2, set to all “1”'s if μ=0; set to all “0”s if μ=1, where μ corresponds to the subcarrier spacing (SCS) of a carrier.
“Redundancy version” bits in the DCI are set to all “0”s.

No deactivation is needed for the aperiodic reporting since a UE only reports a corresponding CSI once in response to receiving the DCI including the CSI request field.

In some embodiments of the present disclosure, a dynamic adaptation of spatial elements is introduced into a communication system. For example, a dynamic adaptation of the port number (e.g., via a port adaptation indication) can save the energy consumed by the network (e.g., a BS) drastically. Muting different port patterns can bring different performances. In the context of the present disclosure, a port may refer to an antenna port or a logical antenna port.

As described above, a CSI report may be associated with a CSI-RS resource with a port number (e.g., P_{CSI-RS}). A UE configured with this report may report a single CSI based on the port number in one CSI report. Thus, the dynamic port adaptation mechanism may have impacts on the CSI report mechanism.

For example, the network may not have accurate CSI tracking to schedule data. For instance, FIG. 2 illustrates a schematic diagram of CSI reporting in accordance with some embodiments of the present disclosure. In FIG. 2, it is assumed that a UE is configured with a CSI-RS resource with 8 ports. Referring to FIG. 2, the UE may receive CSI-RS 1 on the configured CSI-RS resource and may report CSI report 1 based on CSI-RS 1 at time TO. At time T1, the UE may receive a port adaptation indication which indicates that the port number is changed to 32 ports. The UE may receive CSI-RS 2 on the configured CSI-RS resource and may report CSI report 2 based on CSI-RS 2 at time T2. At time T3, the UE may receive a port adaptation indication which indicates that the port number is changed to 8 ports. For a PDSCH scheduled after time T3 as shown in FIG. 2, CSI report 1 may be out-of-date although the associated port number is the same as the current port number (i.e., both are 8); and CSI report 2 may be inaccurate since the associated port number (i.e., 32) is different from the current port number (i.e., 8).

To achieve assistance information for port adaptation and accurate CSI tracking for data transmission, embodiments of the present disclosure provide solutions for supporting multiple CSIs in a CSI report based on different port patterns or port numbers. To achieve multiple CSIs in a CSI report, various issues need to be addressed.

For example, CSI report configuration enhancement is desired to support multiple CSIs in a CSI report. For example, how to configure multiple CSIs to report should be considered. For example, as described above, the codebook configuration is associated with the port number for an associated CSI-RS resource. Since multiple CSIs may be associated with different port numbers, codebook configuration enhancement is also desired. For example, multiple CSIs may have more overhead than a single CSI, and the configured PUCCH resource may not be sufficient. Embodiments of the present disclosure provide solutions for solving the above issues.

Moreover, including multiple CSIs in a CSI report may not always be needed since it may result in higher uplink control information (UCI) content and resource allocation. Embodiments of the present disclosure provide solutions for activating and deactivating such CSI reporting mechanism.

More details on the embodiments of the present disclosure will be illustrated in the following text in combination with the appended drawings.

FIG. 9 illustrates a flow chart of exemplary procedure 900 of wireless communications in accordance with some embodiments of the present disclosure. Procedure 900 may be implemented by a UE (e.g., UE 101 as shown in FIG. 1). Details described in all of the foregoing embodiments of the present disclosure are applicable for the embodiments shown in FIG. 9.

Referring to FIG. 9, in operation 911, a UE may receive one or more CSI reporting configurations, wherein each of the one or more CSI reporting configurations is associated with one or more CSI-RS resources, each of which is configured with a respective port number. The CSI reporting configurations may be received from a BS (e.g., BS 102 as shown in FIG. 1) via RRC signaling.

In operation 913, the UE may receive an indication (denoted as “first indication” for clarity) indicating at least one of the following parameters for CSI reporting: one or more port numbers, one or more port subset patterns, one or more port number scaling factors, whether a single CSI or multiple CSIs are included in a CSI report, or one or more codebook configurations.

In the context of the present disclosure, a port subset pattern may also be referred to as a port pattern. In some embodiments, various port patterns can be predefined for each port number layout. A port number layout refers to a supported configuration of (N₁, N₂) for a port number.

In operation 915, the UE may generate a CSI report (denoted as “first CSI report” for clarity) based on a CSI reporting configuration (denoted as “first CSI reporting configuration” for clarity) of the one or more CSI reporting configurations and the first indication.

In some embodiments of the present disclosure, the first indication may indicate one or more port numbers. In some embodiments of the present disclosure, the first CSI report may include a CSI for each of the one or more port numbers.

For example, the first indication may be represented as follows. It should be noted that the following example is only for illustrative purposes, and other port numbers can be indicated.
Reportedportnumber ENUMERATED {24,16,12}

For example, the CSI-RS resource in the first CSI reporting configuration may be configured with a port number of 32, and the first indication may indicate {24, 12}. In some examples, the first CSI report may include three CSIs associated with 32 ports, 24 ports and 12 ports, respectively, or include two CSIs associated with 24 ports and 12 ports, respectively. In some examples, when multiple-CSI is not activated or deactivated, the first CSI report may include a CSI associated with 32 ports. When multiple-CSI is activated, the first CSI report may include a CSI associated with 32 ports, a CSI associated with 24 ports and a CSI associated with 12 ports, or include a CSI associated with 24 ports and a CSI associated with 12 ports.

In some embodiments of the present disclosure, the first indication may indicate one or more port subset patterns. In some embodiments of the present disclosure, the first CSI report may include a CSI for each of the one or more port subset patterns. Port patterns can be predefined for each port number layout.

For example, the first indication may be represented as follows. It should be noted that the following example is only for illustrative purposes, and other patterns can be indicated.
Reportedportpattern ENUMERATED {pattern 1, pattern 2}

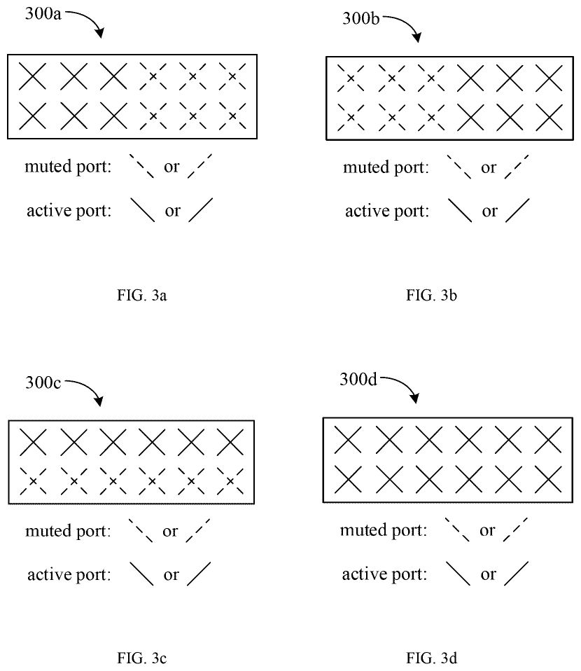

FIGS. 3a-3d show exemplary port subset patterns 300a-300d for a 24-port layout in accordance with some embodiments of the present disclosure. In patterns 300a-300c shown in FIGS. 3a-3c, 12 out of 24 ports are muted. In FIG. 3d, none of the 24 ports are muted.

For example, the CSI-RS resource in the first CSI reporting configuration may be configured with a port number of 24, and the first indication may indicate pattern 1 and pattern 2. It is assumed that patterns 300a and 300b in FIGS. 3a and 3b correspond to pattern 1 and pattern 2, respectively. In some examples, the first CSI report may include three CSIs for patterns 300a, 300b and 300d, respectively, or include two CSIs for patterns 300a and 300b, respectively. In some examples, when multiple-CSI is not activated or deactivated, the first CSI report may include a CSI for pattern 300d. In some examples, when multiple-CSI is activated, the first CSI report may include three CSIs for patterns 300a, 300b and 300d, respectively, or include two CSIs for patterns 300a and 300b, respectively.

In some embodiments of the present disclosure, the first indication may indicate one or more port number scaling factors. In some embodiments of the present disclosure, the first CSI report may include a CSI corresponding to each of the one or more port number scaling factors.

For example, the first indication may be represented as follows. It should be noted that the following example is only for illustrative purposes, and other scaling factors can be indicated.
ReportedPortnumberratio ENUMERATED {3/4,1/2,1/4}

For example, the CSI-RS resource in the first CSI reporting configuration may be configured with a port number of 32, and the first indication may indicate {1/2,1/4} (which suggests 32/2=16 ports and 32/4=8 ports). In some examples, the first CSI report may include three CSIs associated with 32 ports, 16 ports and 8 ports, respectively, or include two CSIs associated with 16 ports and 8 ports, respectively. In some examples, when multiple-CSI is not activated or deactivated, the first CSI report may include a CSI associated with 32 ports. When multiple-CSI is activated, the first CSI report may include three CSIs associated with 32 ports, 16 ports and 8 ports, respectively, or include two CSIs associated with 16 ports and 8 ports, respectively.

In some embodiments of the present disclosure, the first indication may indicate whether a single CSI or multiple CSIs are included in a CSI report. In some embodiments of the present disclosure, the first CSI report may include a CSI for each of a predefined set of port numbers, a CSI for each of a predefined set of port subset patterns, a CSI corresponding to each of a predefined set of port number scaling factors, or any combination thereof.

For example, the first indication may be represented as follows. It should be noted that the following example is only for illustrative purposes.
IsMultiCSI BOOLEAN

In some embodiments, a set of port numbers may be predefined, preconfigured, or configured such that when multiple CSIs are included in a CSI report, the multiple CSIs can be generated based on the predefined set of port numbers. In some embodiments, a set of port subset patterns may be predefined, preconfigured, or configured such that when multiple CSIs are included in a CSI report, the multiple CSIs can be generated based on the predefined set of port subset patterns. In some embodiments, a set of port number scaling factors may be predefined, preconfigured, or configured such that when multiple CSIs are included in a CSI report, the multiple CSIs can be generated based on the predefined set of port number scaling factors. In some embodiments, any combination of a set of port numbers, a set of port subset patterns, or a set of port number scaling factors may be predefined, preconfigured, or configured such that when multiple CSIs are included in a CSI report, the multiple CSIs can be generated based on such combination.

For example, a set of port numbers may be predefined as {24, 12} and the CSI-RS resource in the first CSI reporting configuration may be configured with a port number of 32. In some examples, the first indication indicates that a single CSI is included in a CSI report (e.g., IsMultiCSI=False), and the first CSI report may include a CSI associated with 32 ports. In some examples, the first indication indicates that multiple CSIs are included in a CSI report (e.g., IsMultiCSI=True), and the first CSI report may include three CSIs associated with 32 ports, 24 ports and 12 ports respectively, or include two CSIs associated with 24 ports and 12 ports, respectively. In some examples, the first indication indicates that multiple CSIs are included in a CSI report; and when multiple-CSI is not activated or deactivated, the first CSI report may include a CSI associated with 32 ports, and when multiple-CSI is activated, the first CSI report may include three CSIs associated with 32 ports, 24 ports and 12 ports, respectively, or include two CSIs associated with 24 ports and 12 ports, respectively.

In some embodiments of the present disclosure, the first indication may indicate one or more codebook configurations. In some embodiments of the present disclosure, the first CSI report may include a CSI corresponding to each of the one or more codebook configurations.

For example, each codebook configuration of the one or more codebook configurations may indicate {N₁, N₂} or {Ng, N₁ and N₂}, thereby indicating the port numbers or port patterns to be reported. For example, a port number P_{CSI-RS} can be determined according to P_{CSI-RS}=2N₁N₂ Or P_{CSI-RS}-2N_{g}N₁N₂. A port pattern can be determined based on the value of {N₁, N₂} or the value of {Ng, N₁ and N₂}.

In some embodiments of the present disclosure, the first indication may be received via RRC signaling. For example, the first indication may be included in a CSI reporting configuration. For example, at least one of the one or more CSI reporting configurations may include the first indication. For example, the first CSI reporting configuration may include the first indication.

In some embodiments of the present disclosure, the first indication may be included in a DCI or a MAC CE.

For example, as will be described in the following text, a DCI may be used to activate a CSI reporting configuration(s) or multi-CSI reporting. The DCI may indicate, for example, the port numbers or the port patterns to be reported (e.g., including the first indication). For example, as will be described in the following text, the first indication can reuse a reserved bit(s) in a MAC CE to indicate, for example, the port numbers or the port patterns to be reported.

In some embodiments, in response to the reception of the first indication in the DCI or MAC CE, multi-CSI reporting may be activated and the first indication (e.g., the indicated port numbers or port patterns) can be applied to all CSI reporting configurations, or all active CSI reporting configurations, or the CSI reporting configuration(s) activated by the DCI or MAC CE.

In some embodiments of the present disclosure, at least one (e.g., the first CSI reporting configuration) of the one or more CSI reporting configurations may indicate at least one of the following: a set of port numbers, a set of port subset patterns, a set of port number scaling factors, whether a single CSI or multiple CSIs are included in a CSI report, or a set of codebook configurations.

The first indication may select the one or more port numbers from the set of port numbers, select the one or more port subset patterns from the set of port subset patterns, or select the one or more port number scaling factors from the set of port number scaling factors, or select the one or more codebook configurations from the set of codebook configurations. That is, the one or more port numbers may be selected from the set of port numbers. The one or more port subset patterns may be selected from the set of port subset patterns. The one or more port number scaling factors may be selected from the set of port number scaling factors. The one or more codebook configurations may be selected from the set of codebook configurations. In some examples, a DCI or a MAC CE may include the first indication. That is, a DCI or a MAC CE may indicate the specific port numbers (note that port number scaling factors are also related to port numbers) or port subset patterns from the configured port numbers or port subset patterns for a CSI report.

In some embodiments of the present disclosure, the one or more CSI reporting configurations may not indicate the set of port numbers, the set of port subset patterns, the set of port number scaling factors, whether a single CSI or multiple CSIs are included in a CSI report, or the set of codebook configurations. For example, a DCI or a MAC CE may include the first indication which directly indicates the port numbers or port subset patterns for a CSI report. That is, there is no selection procedure as described above.

In some embodiments of the present disclosure, at least one of the one or more CSI reporting configurations may include the first indication which directly indicates the port numbers or port subset patterns for a CSI report. That is, for the at least one CSI reporting configuration, there is no selection procedure as described above.

In some embodiments of the present disclosure, at least one (e.g., the first CSI reporting configuration) of the one or more CSI reporting configurations may indicate a codebook configuration corresponding to each of the one or more port numbers, each of the one or more port subset patterns, each of the one or more port number scaling factors, each of the predefined set of port numbers, each of the predefined set of port subset patterns, or each of the predefined set of port number scaling factors.

For example, assuming that the CSI-RS resource in the first CSI reporting configuration is configured with a port number of 32, the first CSI reporting configuration may indicate a codebook configuration corresponding to 32 ports. It is further assumed that the first indication indicates {24, 12}. In some embodiments, the first CSI reporting configuration may further indicate two codebook configurations corresponding to 24 ports and 12 ports, respectively. In some embodiments, the first CSI reporting configuration may indicate a codebook configuration for each of configurable port numbers (e.g., 1, 2, 4, 8, 12, 16, 24, or 32 ports).

For example, it is assumed that the CSI-RS resource in the first CSI reporting configuration is configured with a port number of 32 and the predefined set of port numbers is {16, 12}. In addition to indicating a codebook configuration corresponding to 32 ports, the first CSI reporting configuration may further indicate two codebook configurations corresponding to 16 ports and 12 ports, respectively.

In some embodiments of the present disclosure, at least one (e.g., the first CSI reporting configuration) of the one or more CSI reporting configurations may indicate a codebook configuration (hereinafter, denoted as “the first codebook configuration” for clarity) for the respective port number (e.g., the port number of an associated CSI-RS resource).

In some embodiments, a codebook configuration corresponding to each of the one or more port numbers, each of the one or more port subset patterns, each of the one or more port number scaling factors, each of a predefined set of port numbers, each of a predefined set of port subset patterns, or each of a predefined set of port number scaling factors can be determined based on the first codebook configuration.

In some embodiments, a codebook configuration corresponding to at least one of the one or more port numbers, at least one of the one or more port subset patterns, at least one of the one or more port number scaling factors, at least one of a predefined set of port numbers, at least one of a predefined set of port subset patterns, or at least one of a predefined set of port number scaling factors, which is not configured in the a corresponding CSI reporting configuration (e.g., the first CSI reporting configuration) of the one or more CSI reporting configurations can be determined based on the first codebook configuration.

For example, it is assumed that the CSI-RS resource in a CSI reporting configuration (e.g., the first CSI reporting configuration) is configured with P_{CSI-RS} ports and the first CSI reporting configuration indicates a codebook configuration (e.g., the first codebook configuration) for the Pc CSI-RS ports. According to the first codebook configuration, the values of N₁ and N₂ can be determined, where P_{CSI-RS}=2N₁N₂. In some examples, the values of N₁ and N₂ are from a supported configuration table for antenna port numbers (e.g., Table 1 as shown below). Table 1 is only for illustrative purposes and may be predefined, for example, in standards such as 3GPP specifications.

TABLE 1
Supported configurations of (N₁, N₂)

| Number of CSI-RS | |
|---|---|
| antenna ports, P_{CSI-RS} | (N₁, N₂) |
| 4 | (2, 1) |
| 8 | (2, 2) |
| | (4, 1) |
| 12 | (3, 2) |
| | (6, 1) |
| 16 | (4, 2) |
| | (8, 1) |
| 24 | (4, 3) |
| | (6, 2) |
| | (12, 1) |
| 32 | (4, 4) |
| | (8, 2) |
| | (16, 1) |

For clarity and illustrative purposes, it is assumed that the first indication indicates port pattern #1. It should be appreciated by persons skilled in the art that although when the first indication indicates a port number or else other information, the following methods can be similarly applied. A codebook configuration for port pattern #1 can be determined based on the first codebook configuration. Various methods may be employed for such determination.

In some embodiments, one principle for the determination is that the values of N₁′ and N₂′ associated with the codebook configuration for port pattern #1 are from the supported configuration table for antenna port numbers (e.g., Table 1 as shown above) and should satisfy N₁′<=N₁ and N₂′<=N₂. In addition, assuming that the port number of port pattern #1 (denoted as P_{CSI-RS} ‘), P_{CSI-RS}’=2N′ N₂′.

In some examples, the values of N₁′ and N₂′ can be determined based on a mapping relation between the values of N₁′ and N₂′ and the values of N₁and N₂. Table 2 below shows an exemplary mapping relation of the values of N₁′ and N₂′ and the values of N₁ and N₂. Table 2 is only for illustrative purposes and may be predefined, for example, in standards such as 3GPP specifications.

According to Table 2, assuming that that the CSI-RS resource in the first CSI reporting configuration is configured with 32 ports and (N₁, N₂) is configured as (8, 2), when port pattern #1 includes 24 ports, (N₁′, N₂′) can be determined as (6, 2), when port pattern #1 includes 16 ports, (N₁′, N₂′) can be determined as (4, 2) (i.e., first mapped to (6, 2) corresponding to 24 ports and then mapped to (4, 2) corresponding to 16 ports), when port pattern #1 includes 12 ports, (N₁′, N₂′) can be determined as (3, 2) (i.e., (6, 2)→(4, 2)→(3, 2)), when port pattern #1 includes 8 ports, (N₁′, N₂′) can be determined as (2, 2) (i.e., (6, 2)→(4, 2)→(3, 2)→(2, 2)), and when port pattern #1 includes 4 ports, (N₁′, N₂′) can be determined as (2, 1).

In some embodiments, the value of N₁′ and N₂′ associated with the codebook configuration for port pattern #1 can be determined based on port pattern #1. For example, assuming that port pattern #1 is port subset pattern 300a or port subset pattern 300b, which corresponds to (N₁, N₂)=(3, 2), then the value of N₁′ and N₂′ can be determined as (N₁′, N₂′)=(3, 2). For example, assuming that port pattern #1 is port subset pattern 300c, which corresponds to (N₁, N₂)=(6, 1), then the value of N₁′ and N₂′ can be determined as (N₁′, N₂′)=(6, 1).

The codebook subset restriction configuration for port pattern #1 can also be determined by the first codebook configuration. For example, the x^{th} bit in the codebook configuration for port pattern #1 can be determined by n^{th} bit in the first codebook configuration, where 1<=x<=X′ and 1<=n<=N, X′ is related to N₁′ and N₂′ and N is related to N₁ and N₂.

For example, the following pseudo-code shows an exemplary codebook subset restriction for Type I single panel, which shows the relationship between the values of N₁ and N₂ and the value of N. The value of X′ can be determined based on such relationship and the values of N₁′ and N₂′.

| | |
|---|---|
| moreThanTwo | SEQUENCE { |
| n1-n2 | CHOICE { |
| two-one-TypeI-Single Panel-Restriction | BIT STRING (SIZE (8)), |
| two-two-TypeI-Single Panel-Restriction | BIT STRING (SIZE (64)), |
| four-one-TypeI-Single Panel-Restriction | BIT STRING (SIZE (16)), |
| three-two-TypeI-Single Panel-Restriction | BIT STRING (SIZE (96)), |
| six-one-TypeI-Single Panel-Restriction | BIT STRING (SIZE (24)), |
| four-two-TypeI-Single Panel-Restriction | BIT STRING (SIZE (126)), |
| eight-one-TypeI-Single Panel-Restriction | BIT STRING (SIZE (32)), |
| four-three-TypeI-Single Panel-Restriction | BIT STRING (SIZE (192)), |
| six-two-TypeI-Single Panel-Restriction | BIT STRING (SIZE (192)), |
| twelve-one-TypeI-Single Panel-Restriction | BIT STRING (SIZE (48)), |
| four-four-TypeI-Single Panel-Restriction | BIT STRING (SIZE (256)), |
| eight-two-TypeI-Single Panel-Restriction | BIT STRING (SIZE (256)), |
| sixteen-one-TypeI-Single Panel-Restriction | BIT STRING (SIZE (64)), |
| }, | |

For example, it is assumed that the CSI-RS resource in the first CSI reporting configuration is configured with 32 ports and (N₁, N₂) is configured as (8, 2), codebook subset restriction configuration from the first codebook configuration is 256 bits (i.e., N=256) for Type I single panel (i.e., corresponding to “eight-two-TypeI-SinglePanel-Restriction BIT STRING (SIZE (256))” in the above pseudo-code). Assuming that the first indication indicates a port pattern with 16 ports, then (N₁′, N₂′) can be determined as (4, 2) according to Table 2 in some embodiments. Then, according to the above pseudo-code, X′=128 (i.e., corresponding to “four-two-TypeI-SinglePanel-Restriction BIT STRING (SIZE (128))”). The xth (1<=x<=128) codebook subset restriction for the indicated port pattern may be the round (x*(256/128))^{th} (i.e., round (x*(N/X′))^{th}) bit from the first codebook configuration. Any other mapping relationship between the codebook subset restrictions can also be employed.

It should be appreciated by persons skilled in the art that although some of the above embodiments are described with respect to a specific codebook type, these embodiments can be similarly applied to any codebook type.

In some embodiments of the present disclosure, at least one (e.g., the first CSI reporting configuration) of the one or more CSI reporting configurations may indicate a PUCCH resource (denoted as PUCCH #1 for clarity) for a single CSI and another PUCCH resource (denoted as PUCCH #2 for clarity) for multiple CSIs.

For example, the CSI-RS resource in the first CSI reporting configuration may be configured with a port number of 32, and the first indication may indicate {24, 12}. In some examples, the first CSI report may include multiple CSIs (e.g., CSIs respectively associated with 24 ports and 12 ports), when, for example, multiple-CSI is activated, and may be transmitted on PUCCH #2. In some examples, the first CSI report may only include a single CSI associated with a port number of 32 (e.g., when multiple-CSI is not activated or deactivated), and may be transmitted on PUCCH #1.

For example, the CSI-RS resource in the first CSI reporting configuration may be configured with a port number of 24, and the first indication may indicate pattern 1 and pattern 2. In some examples, the first CSI report may include multiple CSIs (e.g., CSIs for pattern 1 and pattern 2), when, for example, multiple-CSI is activated, and may be transmitted on PUCCH #2. In some examples, the first CSI report may only include a single CSI associated with a port number of 24 (e.g., when multiple-CSI is not activated or deactivated), and may be transmitted on PUCCH #1.

For example, the CSI-RS resource in the first CSI reporting configuration may be configured with a port number of 32, and the first indication may indicate {1/2,1/4}. In some examples, the first CSI report may include multiple CSIs (e.g., CSIs associated with 16 ports and 8 ports), when, for example, multiple-CSI is activated, and may be transmitted on PUCCH #2. In some examples, the first CSI report may only include a single CSI associated with a port number of 32 (e.g., when multiple-CSI is not activated or deactivated), and may be transmitted on PUCCH #1.

For example, the first indication may indicate multiple CSIs should be included in a CSI report. A set of port numbers may be predefined as {24, 12} and the CSI-RS resource in the first CSI reporting configuration may be configured with a port number of 32. In some examples, the first CSI report may include multiple CSIs (e.g., CSIs associated with 24 ports and 12 ports), when, for example, multiple-CSI is activated, and may be transmitted on PUCCH #2. In some examples, the first CSI report may only include a single CSI associated with a port number of 32 (e.g., when multiple-CSI is not activated or deactivated), and may be transmitted on PUCCH #1.

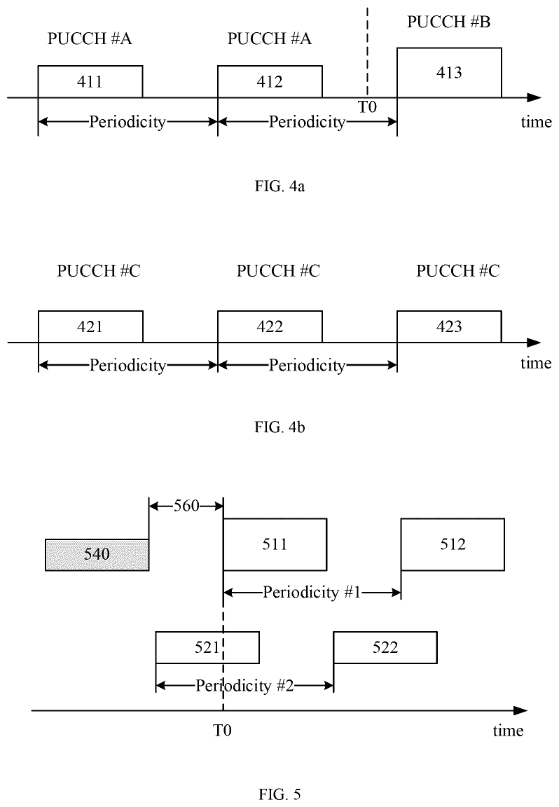

For example, referring to FIG. 4a, a UE may be configured with CSI reporting configuration #1 and may receive a first indication with multi-CSI related information (e.g., port numbers or port patterns as described above). CSI reporting configuration #1 may indicate more than one PUCCH resource for one corresponding BWP for periodic CSI or semi-persistent on a PUCCH. For example, CSI reporting configuration #1 may indicate PUCCH #A for a single CSI and PUCCH #B for multiple CSIs. Time TO represents the timing when multiple CSI reporting becomes effective. Before time T0, the UE may transmit CSI reports 411 and 412, each of which includes a single CSI, on PUCCH #A. After time T0, the UE may transmit CSI report 413 including multiple CSIs on PUCCH #B.

In some embodiments of the present disclosure, at least one (e.g., the first CSI reporting configuration) of the one or more CSI reporting configurations may indicate a PUCCH resource (denoted as PUCCH #1′ for clarity). When the first CSI report includes multiple CSIs, each of the multiple CSIs may be carried on a corresponding time instance of PUCCH #1′.

For example, referring to FIG. 4b, a UE may be configured with CSI reporting configuration #2 and may receive a first indication with multi-CSI related information. CSI reporting configuration #2 may indicate only one PUCCH resource for one corresponding BWP for periodic CSI or semi-persistent on a PUCCH. For example, CSI reporting configuration #2 may indicate PUCCH #C for CSI reporting. Assuming that multiple CSI reporting has become effective in FIG. 4b, the UE may need to report multiple CSIs including CSIs for the port numbers (or port patterns) indicated by the first indication, a CSI for the port number associated with the associated CSI-RS resource, or both.

For example, assuming the CSI-RS resource in CSI reporting configuration #2 is configured with a port number of 32, and the first indication indicates {24, 12}, the CSI report corresponding to CSI reporting configuration #2 may include a CSI associated with a port number of 32 (e.g., CSI 421), a CSI associated with a port number of 24 (e.g., CSI 422), and a CSI associated with a port number of 12 (e.g., CSI 423). As shown in FIG. 4b, the UE may transmit the three CSIs on corresponding time instances of PUCCH #C.

Referring back to FIG. 9, in some embodiments of the present disclosure, the UE may receive another indication (denoted as “second indication” for clarity) activating multiple CSI reporting in a CSI report.

As stated above, a UE may receive one or more CSI reporting configurations. In some embodiments of the present disclosure, the second indication may activate at least one CSI reporting configuration which configures multiple CSI reporting among the one or more CSI reporting configurations.

A CSI reporting configuration which configures (or is configured with) multiple CSI reporting may be a CSI reporting configuration configured with or including a corresponding first indication, which indicates at least one of the following: one or more port numbers, one or more port subset patterns, one or more port number scaling factors, or multiple CSIs being included in a CSI report. The at least one CSI reporting configuration may or may not include the first CSI reporting configuration as described above.

In response to receiving the second indication, multiple CSI reporting in a report can be applied to all CSI report configurations configured with multiple CSI reporting at the UE. For example, the first CSI reporting configuration as mentioned above may be configured with multiple CSI reporting (by a corresponding first indication transmitted via RRC signaling or via a DCI or MAC CE). Multiple CSI reporting in a report may not be activated or may be deactivated before the reception of the second indication, and thus the first CSI report may include only one CSI. However, in response to receiving the second indication, the first CSI report may include multiple CSIs based on the first CSI reporting configuration and the corresponding first indication.

In some embodiments of the present disclosure, the second indication may be a DCI including a CSI request field or an SP CSI reporting on a PUCCH activation/deactivation MAC CE.

For example, as described above, a CSI request in the DCI may indicate a trigger state which may be associated with a CSI reporting configuration or a list of CSI reporting configurations. The UE may validate the DCI as a DCI for CSI activation. When the associated CSI reporting configuration or at least one CSI reporting configuration of the associated list of CSI reporting configurations is configured with multiple CSI reporting, multiple CSI reporting in a report is activated at the UE and may be applied to all CSI report configurations configured with multiple CSI reporting.

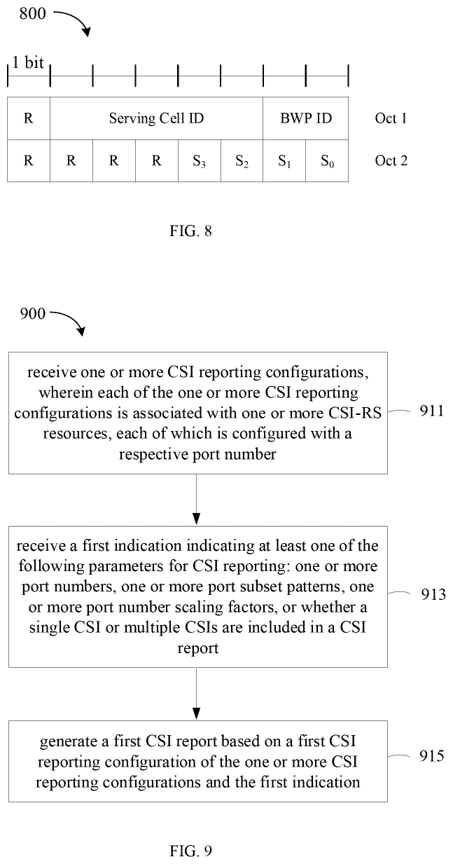

For example, FIG. 8 illustrates an exemplary SP CSI reporting on PUCCH Activation/Deactivation MAC CE 800. Referring to FIG. 8, MAC CE 800 may include 16 bits, where “Serving Cell ID” indicates the identity of the serving cell for which the MAC CE applies and includes 5 bits: “BWP ID” indicates the ID of a downlink BWP for which the MAC CE applies and includes 2 bits; “R” represents a reserved bit and may be set to “0”; and “Sᵢ” (i∈{0, 1, 2, 3}) represents the SP CSI reporting configuration to be activated or deactivated. For example, Sᵢ=“1” may indicate a corresponding SP CSI reporting configuration should be activated and Sᵢ=“0” may indicate the corresponding SP CSI reporting configuration should be deactivated, or vice versa.

A UE may receive an SP CSI reporting on a PUCCH Activation/Deactivation MAC CE which activates at least one SP CSI reporting configuration configured with multiple CSI reporting. In response to receiving the MAC CE, multiple CSI reporting in a report can be applied to all CSI report configurations configured with multiple CSI reporting (including but not limited to the at least one activated SP CSI reporting configuration).

For example, referring to FIG. 5, a UE may be configured with CSI reporting configuration #A1 with a periodicity of Periodicity #1 and CSI reporting configuration #A2 with a periodicity of Periodicity #2. In some examples, both CSI reporting configuration #A1 and CSI reporting configuration #A2 may be configured with multiple CSI reporting. In some examples, CSI reporting configuration #A1 may be an SP CSI reporting configuration. In some examples, CSI reporting configuration #A2 may be a periodic CSI reporting configuration.

The UE may receive DCI 540 which activates CSI reporting configuration #A1. Multiple CSI reporting activation may become effective after offset 560 from the DCI (e.g., at time TO). The value of offset 560 may be predefined, preconfigured, or configured. Since CSI report 511 and CSI report 512 corresponding to CSI reporting configuration #A1 are transmitted after time TO, CSI report 511 and CSI report 512 may include multiple CSIs. The methods for generating the multiple CSIs as described above can apply here.

The multiple CSI reporting indication may also be applied to CSI reporting configuration #A2. Since CSI report 521 corresponding to CSI reporting configuration #A2 is not transmitted after time TO (e.g., the resource used to transmitted the CSI is not all after time TO), CSI report 521 may include a single CSI. Since CSI report 522 corresponding to CSI reporting configuration #A2 is transmitted after time TO, CSI report 522 may include multiple CSIs. The methods for generating the multiple CSIs as described above can apply here.

Referring back to FIG. 9, as described above, the first CSI reporting configuration may be configured with multiple CSI reporting and the first CSI report may include multiple CSIs in response to receiving the second indication. In some embodiments of the present disclosure, the first CSI report may include a single CSI (i.e., “multiple CSIs in a CSI report” is deactivated) in response to one of the following conditions: the UE receiving a port adaptation indication, the UE receiving a third indication deactivating multiple CSI reporting in a CSI report, or after a time offset from the reception of the second indication. The value of the time offset may be predefined, preconfigured, or configured.

In some embodiments of the present disclosure, the third indication may be a DCI including a CSI request field or an SP CSI reporting on a PUCCH activation/deactivation MAC CE (e.g., MAC CE 800 in FIG. 8).

For example, as described above, a CSI request in the DCI may indicate a trigger state which may be associated with a CSI reporting configuration or a list of CSI reporting configurations. The UE may validate the DCI as a DCI for CSI deactivation. When the associated CSI reporting configuration or at least one CSI reporting configuration of the associated list of CSI reporting configurations is configured with multiple CSI reporting, multiple CSI reporting in a report is deactivated and may be applied to all CSI report configurations configured with multiple CSI reporting.

For example, a UE may receive an SP CSI reporting on a PUCCH Activation/Deactivation MAC CE which provides the status (i.e., either activated or deactivated) of several SP CSI reporting configurations (e.g., indicated by Sᵢ in FIG. 8), when all CSI report configurations configured with multiple CSI reporting among the CSI report configurations that can be indicated by the MAC CE are deactivated, multiple CSI reporting in a report is deactivated and may be applied to all CSI report configurations configured with multiple CSI reporting.

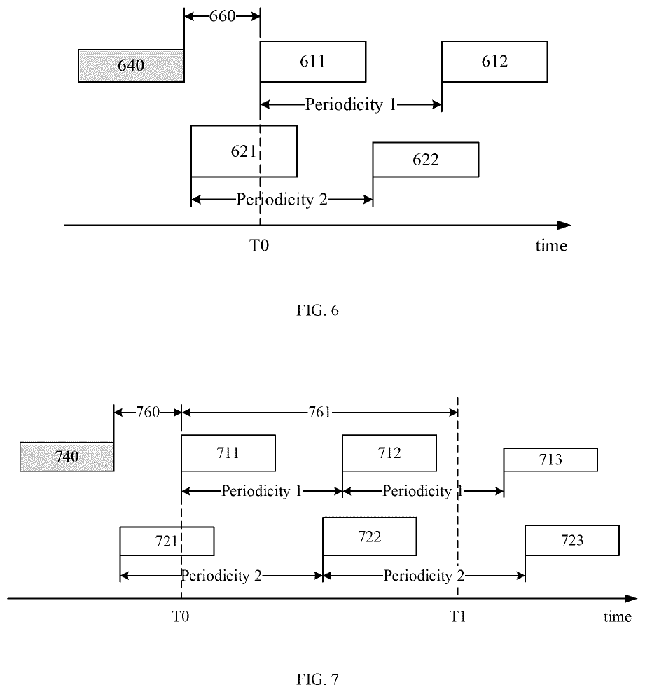

For example, referring to FIG. 6, a UE may be configured with CSI reporting configuration #B1 with a periodicity of Periodicity #1 and CSI reporting configuration #B2 with a periodicity of Periodicity #2. In some examples, both CSI reporting configuration #B1 and CSI reporting configuration #B2 may be configured with multiple CSI reporting. In some examples, CSI reporting configuration #B1 may be an SP CSI reporting configuration. In some examples, CSI reporting configuration #B2 may be a periodic CSI reporting configuration. It is assumed that multiple CSI reporting in a report is activated. The UE may transmit CSI reports corresponding to CSI reporting configuration #B1 and CSI reporting configuration #B2, and these CSI reports may include multiple CSIs.

Then, the UE may receive port adaptation indication 640 (for example, adjusting the port number from 32 to 16), which may become effective after offset 660 from port adaptation indication 640 (e.g., at time TO). The value of offset 660 may be predefined, preconfigured, or configured.

Since CSI report 611 and CSI report 612 corresponding to CSI reporting configuration #B1 are transmitted after time TO, CSI report 611 and CSI report 612 may include a single CSI. Since CSI report 621 corresponding to CSI reporting configuration #B2 is not transmitted after time TO, CSI report 621 may still include multiple CSIs. Since CSI report 622 corresponding to CSI reporting configuration #B2 is transmitted after time TO, CSI report 622 may include a single CSIs.

It should be noted that if port adaptation indication 640 in FIG. 6 is replaced by a third indication (i.e., a semi-persistent CSI deactivation signal) which deactivates CSI reporting configuration #B1, then CSI report 611 and CSI report 612 may not be transmitted.

For example, referring to FIG. 7, a UE may be configured with CSI reporting configuration #C1 with a periodicity of Periodicity #1 and CSI reporting configuration #C2 with a periodicity of Periodicity #2. In some examples, both CSI reporting configuration #C1 and CSI reporting configuration #C2 may be configured with multiple CSI reporting. In some examples, CSI reporting configuration #C1 may be an SP CSI reporting configuration. In some examples, CSI reporting configuration #C2 may be a periodic CSI reporting configuration.

The UE may receive DCI 740 which activates CSI reporting configuration #C1. Multiple CSI reporting activation may become effective after offset 760 from the DCI (e.g., at time TO). In some embodiments, after a certain time from the reception of DCI 740 (e.g., offest 760+offset 761) or after a certain time from time TO (e.g., offset 761), multiple CSI reporting may become deactivated (e.g., at time T1). The value of offset 760, the value of offset 761 and/or the value of offest 760+offset 761 may be predefined, preconfigured, or configured.

Since CSI report 711 and CSI report 712 corresponding to CSI reporting configuration #C1 are transmitted after time T0 and before time T1, CSI report 711 and CSI report 712 may include multiple CSIs. Since CSI report 713 corresponding to CSI reporting configuration #C1 is transmitted after time T1, CSI report 713 may include a single CSI.

Since CSI report 721 corresponding to CSI reporting configuration #C2 is not transmitted after time T0 and CSI report 723 corresponding to CSI reporting configuration #C2 is transmitted after time T1, CSI report 721 and CSI report 723 may include a single CSI. Since CSI report 722 corresponding to CSI reporting configuration #C2 is transmitted after time T0 and before time T1, CSI report 722 may include multiple CSIs.

In some embodiments of the present disclosure, the first indication may reuse a reserved bit(s) in an SP CSI reporting on a PUCCH Activation/Deactivation MAC CE.

For example, an SP CSI reporting on a PUCCH Activation/Deactivation MAC CE may indicate the port numbers or the port patterns to be reported. For example, referring again to FIG. 8, MAC CE 800 may be used to activate or deactivate multiple CSI reporting. All or some of the five “R” bits of MAC CE 800 may be used to indicate the port numbers or the port patterns to be reported. For example, the indicated port numbers or the port patterns may be applied to the SP CSI reporting configuration(s) activated by MAC CE 800. For example, the indicated port numbers or the port patterns may be applied to the one or more CSI reporting configurations. In an example, if all the reserved bits are “0” (i.e., set to a predefined value), multiple CSI reporting is not activated or is deactivated.

It should be appreciated by persons skilled in the art that the sequence of the operations in exemplary procedure 900 may be changed and some of the operations in exemplary procedure 900 may be eliminated or modified, without departing from the spirit and scope of the disclosure.

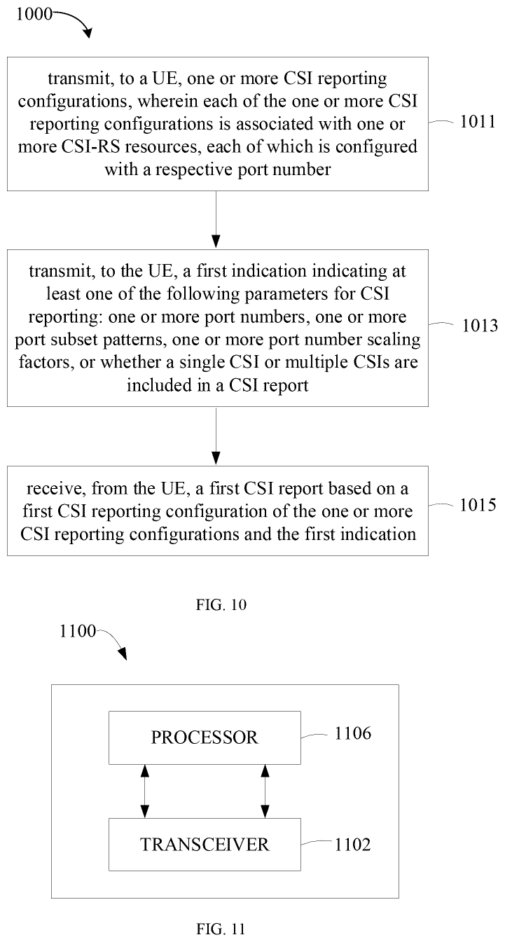

FIG. 10 illustrates a flow chart of exemplary procedure 1000 for wireless communications in accordance with some embodiments of the present disclosure. Details described in all of the foregoing embodiments of the present disclosure are applicable for the embodiments shown in FIG. 10. In some examples, the procedure may be performed by a BS, for example, BS 102 in FIG. 1.

Referring to FIG. 10, in operation 1011, a BS may transmit, to a UE, one or more CSI reporting configurations, wherein each of the one or more CSI reporting configurations is associated with one or more CSI-RS resources, each of which is configured with a respective port number. The descriptions regarding the CSI reporting configuration in the forgoing embodiments may apply here.

In operation 1013, the BS may transmit, to the UE, a first indication indicating at least one of the following parameters for CSI reporting: one or more port numbers, one or more port subset patterns, one or more port number scaling factors, whether a single CSI or multiple CSIs are included in a CSI report, or one or more codebook configurations. The descriptions regarding the first indication in the forgoing embodiments may apply here.

In operation 1015, the BS may receive, from the UE, a first CSI report based on a first CSI reporting configuration of the one or more CSI reporting configurations and the first indication. The descriptions regarding the first CSI reporting configuration and the first CSI report in the forgoing embodiments may apply here.

In some embodiments of the present disclosure, the first indication is transmitted via RRC signaling. In some embodiments of the present disclosure, the first indication is included in a DCI or a MAC CE.

In some embodiments of the present disclosure, the first CSI reporting configuration indicates at least one of the following: a set of port numbers, a set of port subset patterns, a set of port number scaling factors, whether a single CSI or multiple CSIs are included in a CSI report, or a set of codebook configurations. In some embodiments of the present disclosure, the one or more port numbers are selected from the set of port numbers. In some embodiments of the present disclosure, the one or more port subset patterns are selected from the set of port subset patterns. In some embodiments of the present disclosure, the one or more port number scaling factors are selected from the set of port number scaling factors. In some embodiments of the present disclosure, the one or more codebook configurations may be selected from the set of codebook configurations.

In some embodiments of the present disclosure, the first CSI report includes a CSI for each of the one or more port numbers. In some embodiments of the present disclosure, the first CSI report includes a CSI for each of the one or more port subset patterns. In some embodiments of the present disclosure, the first CSI report includes a CSI corresponding to each of the one or more port number scaling factors. In some embodiments of the present disclosure, the first CSI report includes a CSI for each of a predefined set of port numbers. In some embodiments of the present disclosure, the first CSI report includes a CSI for each of a predefined set of port subset patterns. In some embodiments of the present disclosure, the first CSI report includes a CSI corresponding to each of a predefined set of port number scaling factors. In some embodiments of the present disclosure, the first CSI report includes a CSI corresponding to each of the one or more codebook configurations.

In some embodiments of the present disclosure, the descriptions regarding the codebook configuration in the forgoing embodiments may apply here.

For example, in some embodiments of the present disclosure, the first CSI reporting configuration indicates a codebook configuration corresponding to each of the one or more port numbers, each of the one or more port subset patterns, each of the one or more port number scaling factors, each of a predefined set of port numbers, each of a predefined set of port subset patterns, or each of a predefined set of port number scaling factors.

In some embodiments of the present disclosure, the first CSI reporting configuration indicates a first codebook configuration for the respective port number. A codebook configuration corresponding to each of the one or more port numbers, each of the one or more port subset patterns, each of the one or more port number scaling factors, each of a predefined set of port numbers, each of a predefined set of port subset patterns, or each of a predefined set of port number scaling factors is based on the first codebook configuration.

In some embodiments of the present disclosure, the descriptions regarding the PUCCH resource indication in the forgoing embodiments may apply here.

In some embodiments of the present disclosure, the first CSI reporting configuration indicates a first PUCCH resource (e.g., PUCCH #1 as described above) for a single CSI and a second PUCCH resource (e.g., PUCCH #2 as described above) for multiple CSIs.

In some embodiments of the present disclosure, the first CSI reporting configuration indicates a first PUCCH resource (e.g., PUCCH #1′ as described above). The first CSI report may include multiple CSIs. Receiving the first CSI report may include receiving each of the multiple CSIs on a corresponding time instance of the first PUCCH resource.

In some embodiments of the present disclosure, the BS may transmit, to the UE, a second indication activating multiple CSI reporting in a CSI report. In some embodiments of the present disclosure, the descriptions regarding the second indication in the forgoing embodiments may apply here.

For example, in some embodiments of the present disclosure, the second indication activates at least one CSI reporting configuration which configures multiple CSI reporting among the one or more CSI reporting configurations. The first indication may configure the first CSI reporting configuration with multiple CSI reporting. Receiving the first CSI report may include receiving the first CSI report including multiple CSIs in response to the transmission of the second indication.

In some embodiments of the present disclosure, the first CSI report may include a single CSI in response to the BS transmitting a port adaptation indication to the UE, or in response to the BS transmitting a third indication deactivating multiple CSI reporting in a CSI report to the UE, or after a time offset from the transmission of the second indication. In some embodiments of the present disclosure, the descriptions regarding the third indication in the forgoing embodiments may apply here.

In some embodiments of the present disclosure, the second or third indication is a DCI including a CSI request field or an SP CSI reporting on a PUCCH activation/deactivation MAC CE.

In some embodiments of the present disclosure, the first indication reuses a reserved bit(s) in an SP CSI reporting on a PUCCH activation/deactivation MAC CE.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 11 illustrates a block diagram of exemplary apparatus 1100 according to some embodiments of the present disclosure. As shown in FIG. 11, the apparatus 1100 may include at least one processor 1106 and at least one transceiver 1102 coupled to the processor 1106. The apparatus 1100 may be a UE or a BS.

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory and/or other components.

In some embodiments of the present application, the apparatus 1100 may be a UE. The transceiver 1102 and the processor 1106 may interact with each other so as to perform the operations with respect to the UE described in FIGS. 1-10. In some embodiments of the present application, the apparatus 1100 may be a BS. The transceiver 1102 and the processor 1106 may interact with each other so as to perform the operations with respect to the BS described in FIGS. 1-10.

In some embodiments of the present application, the apparatus 1100 may further include at least one non-transitory computer-readable medium.

For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

In some embodiments of the present disclosure, the non-transitory computer-readable medium may have stored thereon computer-executable instructions to cause the processor 1106 to implement the method with respect to the BS as described above. For example, the computer-executable instructions, when executed, cause the processor 1106 interacting with transceiver 1102 to perform the operations with respect to the BS described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive one or more channel state information (CSI) reporting configurations, wherein each of the one or more CSI reporting configurations is associated with one or more CSI reference signal (CSI-RS) resources, each of which is configured with a respective port number;
receive a first indication indicating at least one of the following parameters for CSI reporting: one or more port numbers, one or more port subset patterns, one or more port number scaling factors, whether a single CSI or multiple CSIs are included in a CSI report, or one or more codebook configurations; and
generate a first CSI report based on a first CSI reporting configuration of the one or more CSI reporting configurations and the first indication.

2. The UE of claim 1, wherein the first indication is received via radio resource control (RRC) signaling; or
wherein the first indication is included in downlink control information (DCI) or a medium access control (MAC) control element (CE).

3. The UE of claim 1, wherein the first CSI reporting configuration indicates at least one of the following: a set of port numbers, a set of port subset patterns, a set of port number scaling factors, whether a single CSI or multiple CSIs are included in a CSI report, or a set of codebook configurations.

4. The UE of claim 3, wherein the one or more port numbers are selected from the set of port numbers; or
wherein the one or more port subset patterns are selected from the set of port subset patterns; or
wherein the one or more port number scaling factors are selected from the set of port number scaling factors; or
wherein the one or more codebook configurations are selected from the set of codebook configurations.

5. The UE of claim 1, wherein the first CSI report comprises a CSI for each of the one or more port numbers; or
wherein the first CSI report comprises a CSI for each of the one or more port subset patterns; or
wherein the first CSI report comprises a CSI corresponding to each of the one or more port number scaling factors; or
wherein the first CSI report comprises a CSI for each of a predefined set of port numbers; or
wherein the first CSI report comprises a CSI for each of a predefined set of port subset patterns; or
wherein the first CSI report comprises a CSI corresponding to each of a predefined set of port number scaling factors; or
wherein the first CSI report comprises a CSI corresponding to each of the one or more codebook configurations.

6. The UE of claim 1, wherein the first CSI reporting configuration indicates a first codebook configuration for the respective port number, and wherein a codebook configuration corresponding to each of the one or more port numbers, each of the one or more port subset patterns, each of the one or more port number scaling factors, each of a predefined set of port numbers, each of a predefined set of port subset patterns, or each of a predefined set of port number scaling factors is based on the first codebook configuration.

7. The UE of claim 1, wherein the first CSI reporting configuration indicates a first physical uplink control channel (PUCCH) resource for a single CSI and a second PUCCH resource for multiple CSIs.

8. The UE of claim 1, wherein the first CSI reporting configuration indicates a first physical uplink control channel (PUCCH) resource, the first CSI report comprises multiple CSIs, and each of the multiple CSIs is carried on a corresponding time instance of the first PUCCH resource.

9. The UE of claim 1, wherein the at least one processor is further configured to cause the UE to receive a second indication activating multiple CSI reporting in a CSI report.

10. The UE of claim 109, wherein the second indication activates at least one CSI reporting configuration, which configures multiple CSI reporting among the one or more CSI reporting configurations; and
wherein the first indication configures the first CSI reporting configuration with multiple CSI reporting and the first CSI report comprises multiple CSIs in response to the reception of the second indication.

11. The UE of claim 10, wherein the first CSI report comprises a single CSI in response to the UE receiving a port adaptation indication, er in response to the UE receiving a third indication deactivating multiple CSI reporting in a CSI report, or after a time offset from the reception of the second indication.

12. The UE of claim 10, wherein the second or third indication is downlink control information (DCI) comprising a CSI request field or a semi-persistent (SP) CSI reporting on physical uplink control channel (PUCCH) activation/deactivation medium access control (MAC) control element (CE).

13. The UE of claim 1, wherein the first indication reuses a reserved bit in a semi-persistent (SP) CSI reporting on physical uplink control channel (PUCCH) activation/deactivation medium access control (MAC) control element (CE).

14. A base station (BS) for wireless communication, comprising:
at least one memory; and
at least one processor coupled with the at least one memory and configured to cause the BS to:
transmit, to a user equipment (UE), one or more channel state information (CSI) reporting configurations, wherein each of the one or more CSI reporting configurations is associated with one or more CSI reference signal (CSI-RS) resources, each of which is configured with a respective port number;
transmit, to the UE, a first indication indicating at least one of the following parameters for CSI reporting: one or more port numbers, one or more port subset patterns, one or more port number scaling factors, whether a single CSI or multiple CSIs are included in a CSI report, or one or more codebook configurations; and
receive, from the UE, a first CSI report based on a first CSI reporting configuration of the one or more CSI reporting configurations and the first indication.

15. A method performed by a user equipment (UE), comprising:
receiving one or more channel state information (CSI) reporting configurations, wherein each of the one or more CSI reporting configurations is associated with one or more CSI reference signal (CSI-RS) resources, each of which is configured with a respective port number;
receiving a first indication indicating at least one of the following parameters for CSI reporting: one or more port numbers, one or more port subset patterns, one or more port number scaling factors, whether a single CSI or multiple CSIs are included in a CSI report, or one or more codebook configurations; and
generating a first CSI report based on a first CSI reporting configuration of the one or more CSI reporting configurations and the first indication.

16. The method of claim 15, wherein the first indication is received via radio resource control (RRC) signaling; or
wherein the first indication is included in downlink control information (DCI) or a medium access control (MAC) control element (CE).

17. The method of claim 15, wherein the first CSI reporting configuration indicates at least one of the following: a set of port numbers, a set of port subset patterns, a set of port number scaling factors, whether a single CSI or multiple CSIs are included in a CSI report, or a set of codebook configurations.

18. The method of claim 15, wherein the first CSI reporting configuration indicates a first physical uplink control channel (PUCCH) resource for a single CSI and a second PUCCH resource for multiple CSIs.

19. The method of claim 15, wherein the first CSI reporting configuration indicates a first physical uplink control channel (PUCCH) resource, the first CSI report comprises multiple CSIs, and each of the multiple CSIs is carried on a corresponding time instance of the first PUCCH resource.

20. A method performed by a base station (BS), the method comprising:
transmitting, to a user equipment (UE), one or more channel state information (CSI) reporting configurations, wherein each of the one or more CSI reporting configurations is associated with one or more CSI reference signal (CSI-RS) resources, each of which is configured with a respective port number;
transmitting, to the UE, a first indication indicating at least one of the following parameters for CSI reporting: one or more port numbers, one or more port subset patterns, one or more port number scaling factors, whether a single CSI or multiple CSIs are included in a CSI report, or one or more codebook configurations; and
receiving, from the UE, a first CSI report based on a first CSI reporting configuration of the one or more CSI reporting configurations and the first indication.
